(19) United States
(12) Patent Application Publication
(10) Pub. No.: US 2010/0127419 A1
(43) Pub. Date: May 27, 2010

(54) CERAMIC HONEYCOMB EXTRUSION METHOD AND APPARATUS

(76) Inventors: Christopher John Malarkey, Corning, NY (US); Kenneth Charles Sariego, Beaver Dams, NY (US); Balaji Venkatesan Swarnamani, Horseheads, NY (US); David Robertson Treacy, JR., Horseheads, NY (US)

Correspondence Address: CORNING INCORPORATED, SP-TI-3-1, CORNING, NY, 14831, US

(21) Appl. No.: 12/578,786

(22) Filed: Oct. 14, 2009

Related U.S. Application Data
(60) Provisional application No. 61/117,312, filed on Nov. 24, 2008.

(51) Int. Cl. B29C 47/88; B29C 47/12

(52) U.S. Cl. 264/177.11; 425/144

(57) ABSTRACT

Honeycomb shapes are extruded from plasticized ceramic powder mixtures by methods that include reducing the core temperature of the charge of the plasticized mixture during transit through the extruder, such methods being carried out utilizing apparatus comprising twin-screw extruders incorporating actively cooled screw elements, whereby temperature-conditioned charges of plasticized material that exhibit reduced core-to-periphery temperature differentials are delivered for extrusion.

### CROSS-REFERENCE TO RELATED APPLICATIONS

This application claims the benefit of priority under 35 U.S.C. §119(e) of U.S. Provisional Application Ser. No. 61/117,312 filed on Nov. 24, 2008.

### BACKGROUND

1. Field

The present disclosure is in the field of technical ceramics manufacture, and particularly relates to improved methods and apparatus for the manufacture of large ceramic honeycombs useful for the treatment of exhaust gases from combustion exhaust sources such as auto and diesel motor vehicle engines.

2. Technical Background

The manufacture of ceramic honeycomb structures by the process of plasticizing ceramic powder batch mixtures, extruding the mixtures through honeycomb extrusion dies to form honeycomb extrudate, and drying and firing the extrudate to produce ceramic honeycombs of high strength and good thermal durability, is well known. The ceramic honeycombs thus produced are widely used as ceramic catalyst supports in motor vehicle exhaust systems, and as catalyst supports and wall-flow particulate filters for the removal of soot and other particulates from diesel engine exhausts.

Among the commercially successful processes for ceramic honeycomb manufacture are those that utilize large, co-rotating twin screw extruders for the mixing and extruding of ceramic honeycomb extrudate. These machines offer the capability of homogenizing and plasticizing ceramic powder batch mixtures and pressure-forcing the mixtures through honeycomb extrusion dies, such as in a single continuous processing operation. The favorable economics of this approach extend from the high-volume production of honeycombs of relatively small diameter for automobile exhaust systems to the shaping of Very Large Frontal Area (VLFA) honeycombs for large diesel engine exhaust systems. Cylindrical honeycomb shapes having cross-sectional diameters measured transversely to the cylinder axis and direction of honeycomb channel orientation can range from as small as 5 cm up to 50 cm or more.

One problem attending the production of VLFA honeycombs via twin-screw extrusion, however, is that of delivering a plasticized powder batch mixture to the inlet of a honeycomb extrusion die in a condition of high homogeneity and uniform stiffness. As the diameter of the charge of plasticized material increases, the likelihood increases that viscosity variations arising across that diameter will give rise to uneven rates of extrusion through the honeycomb dies. Among the results of non-uniform feed viscosity observed in the past are extrudate cracking as well as “fast-flow” regions (localized regions of high extrusion speed) that cause channel wall distortions and/or channel wall discontinuities.

Heat exchange jacketing of the barrels of twin screw extruders has been used in the past to enable barrel cooling, in order to limit peak extrudate temperatures. Excessive heating of ceramic powder mixtures comprising cellulosic binder additives such as cellulose ethers can result in gelling and precipitous stiffening of the mixtures. But peripheral controls on barrel temperature are not sufficient to insure temperature uniformity in batch charges of high volume and large cross-section, especially at the high feed rates needed for the economic production of large-diameter honeycomb products. In theory, feed rate reductions could improve temperature uniformity, but the rate reductions required to achieve a useful level of temperature control are so low as to be uneconomic.

Heating means adapted for mounting at the extruder outlet or extrusion die inlet, referred to in the art as front-end heating, have also been tried, the aim again being to deliver plasticized material to the die that is of more uniform temperature and viscosity. This approach can be adequate to improve flow uniformity in batch charges of relatively small cross-section, but the thermal conductivity and heat capacity of present commercial batch formulations are such that none of these previously developed solutions is effective to manage die inlet temperature and viscosity profiles in batch charges of large volume and large cross-section. Thus differential flow problems with the use of twin screw extruders for the manufacture of VLFA and other honeycomb products remain.

### SUMMARY

The high-volume production of ceramic honeycombs by twin-screw extrusion processes involves difficulties that are somewhat unique to the method and material, arising from the internal frictional heating characteristics of plasticized ceramic powder mixtures and the heating effects of co-rotating twin-screw pumping elements on the temperatures of such mixtures. Ceramic powder batches are highly loaded inorganic powder formulations incorporating high proportions of insoluble mineral powders, oxides, and compounds convertible to oxides through later ceramic processing, and relatively low concentrations of vehicles, plasticizers, and lubricants. The frictional heating of these mixtures in the course of plasticization, transport and pressurization at the discharge ends of twin-screw extruders results in the development of a hot core of material spaced from the extruder barrel that cannot be effectively temperature-controlled by peripheral cooling means such as extruder barrel coolants. The end result is that the charge of plasticized material delivered to the extrusion die typically consists of a hot core and a cool periphery, with the core and periphery exhibiting significant differences in viscosity. These differences can result in different extrusion rates through different sections of the extrusion dies, and unacceptable shape defects in the honeycomb extrudate issuing from the dies.

We have found that actively cooling the shafts of co-rotating twin-screw extruder screws provides significant benefits in terms of limiting the temperature differentials arising within plasticized ceramic materials delivered to honeycomb extrusion dies. As a result, the flow fronts of the extruded plasticized material are more uniform, i.e., relatively free of fast-flow regions, even where the extrudate is of relatively large cross-section. Further, the high cooling efficiency of the method results in an overall temperature reduction within the plasticized material that permits extrudate feed rates significantly higher than can be achieved without such cooling, with little risk of shape defects in the honeycomb extrudate.

In one aspect, therefore, methods for shaping plasticized inorganic powder mixtures into honeycomb products are disclosed herein that comprise processing the mixtures through twin-screw extruders that incorporate a pair of actively cooled co-rotating screw elements. Embodiments of those methods include those wherein extrusion is carried out using a combination of screw cooling and cooling of the barrel of the extruder, that combination providing even better control over temperature and viscosity gradients within the extrudate under many extrusion conditions. In its more effective forms the step of active screw cooling generally includes the step of introducing a fluid coolant into bores provided in the shafts of each of the extruder screws.

In another aspect methods for forming honeycomb shapes from plasticized ceramic powder mixtures are disclosed herein wherein the core temperatures of charges of the plasticized mixtures traversing a twin-screw extruder are reduced prior to delivery of the charges to the discharge end of the extruder. The core-cooled or temperature-conditioned mixtures thus produced are then extruded through a honeycomb extrusion die mounted downstream of the discharge end of the extruder, with the resulting honeycomb extrudate exhibiting a reduced incidence of fast-flow shape defects, and in many cases at increased extrusion rates. Such methods may be effectively carried out utilizing twin-screw extruders incorporating co-rotating screw elements, with the reduction in core temperature of the plasticized charge being effected by the active cooling of the each of the screw elements. For the purposes of the present description a charge of ceramic powder mixture, or of a plasticized mixture produced by the processing of the powder mixture, simply refers to that segment of either mixtures lying within or being discharged from the extruder in the course of extruder operation.

In yet another aspect, a twin-screw extruder of improved design is disclosed herein, that extruder incorporating a pair of co-rotating screw elements disposed within the barrel of the extruder, with each screw element being actively cooled. For the purpose of active cooling each screw element incorporates a shaft provided with a central bore for the passage of a fluid coolant. The bore has an inlet opening proximate to the inlet end of the extruder and extends through the shaft from that opening to a closed or terminal bore end located proximate to the discharge end of the extruder.

For most effective cooling of the screw and any plasticized ceramic material in contact therewith, a coolant delivery conduit extending into and disposed within the central bore may be provided. That conduit includes a coolant inlet for a screw coolant, which inlet is generally proximate to the inlet end of the extruder, that conduit extending through the bore from the inlet to a coolant outlet at the terminal end of the conduit. The coolant outlet and terminal conduit end are generally disposed proximate to the end of the bore and are thus proximate to the discharge end of the extruder.

Further features of twin-screw extruders such as disclosed herein include additional cooling means, such as a cooling jacket, disposed to circulate a barrel coolant about the barrel of the extruder. In some embodiments, temperature control means for independently controlling the temperatures of the screw coolant and the barrel coolant are provided, such independent control contributing to cooling strategies for the more effective management of temperature gradients arising between the cores and peripheries of charges of plasticized ceramic powder mixtures delivered to the outlet of the extruders.

### BRIEF DESCRIPTION OF THE DRAWINGS

The invention is further described below with reference to the appended drawings, wherein

FIG. 1 is a schematic view in partial cross-section, not in true proportion or to scale, of a conventional twin screw extruder of the kind useful for the plasticization and extrusion of ceramic powder mixtures;

FIG. 2 is a schematic illustration, not in true proportion or to scale, of a barrel section of a twin-screw extruder incorporating a pair of actively cooled screw elements; and

FIG. 3 is a graph plotting retained shaft torque capacity against central bore diameter for an extruder screw incorporating a central bore for active screw cooling.

### DETAILED DESCRIPTION

The methods and apparatus disclosed herein are generally applicable to the production of any of a number of complex ceramic shapes via the plasticization and extrusion of inorganic powder-filled mixtures from screw extruders operated in modes where high core temperatures are a problem. However, certain embodiments of the invention are particularly useful for the management of the large thermal gradients that arise during the processing of highly filled ceramic powder mixtures through co-rotating twin screw extruders, especially where large-diameter honeycomb structures are to be manufactured. Accordingly the descriptions that follow are presented with specific reference to such extrusion even though the utility of the invention is not limited thereto.

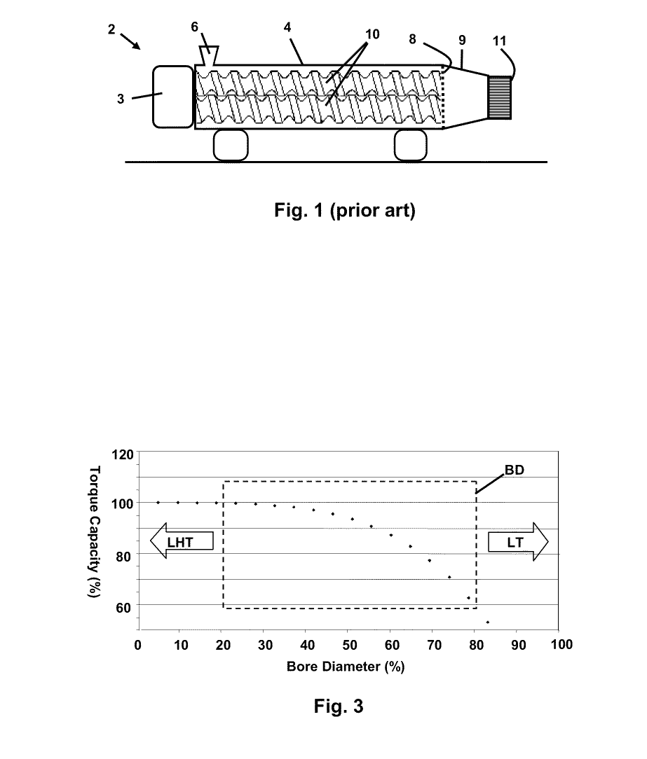

FIG. 1 of the drawings presents a schematic elevational view, in partial cross-section, of a twin-screw extruder 2 of the prior art. That extruder includes an inlet 6 for introducing a starting ceramic powder mixture into extruder barrel 4 where it can be processed by co-rotating screw elements 10. Those screw elements, powered by extruder shaft motor 3, plasticize and transport the starting ceramic powder mixture through barrel 4 to extruder discharge end 8 where it is discharged under pressure into extruder front end 9. The plasticized mixture accumulating in front end 9 is then forced under pressure through extrusion die 11 for forming into honeycomb extrudate.

As noted above, the extraction of heat from the periphery of charges of plasticized ceramic mixtures being processed through twin-screw extruders can be useful for preventing the frictional overheating of such mixtures during the course of mixing and plasticization. The use of extruder barrel cooling systems to prevent such overheating, however, can foster the development of substantial thermal gradients within the extruder barrel that can make it more difficult to maintain uniform extrusion rates across the diameters of honeycomb extrudates. Basically, honeycomb extrudate formed by the extrusion of plasticized ceramic powder mixtures under conditions where large core-to-periphery temperature gradients exist can exhibit a high degree of deformation or disruption of the honeycomb channel structure, or even fracturing of the extrudate, in the course of extrusion from a honeycomb extrusion die. Such disruption is particularly evident over a broad central region of the extrudate, and is caused by the fast flow of the heated core material through the die.

Reportedly, the use of supplemental peripheral heating devices in the front end section of the extruder between the extruder discharge port and the honeycomb extrusion die can help to manage such gradients in the case of thin-walled honeycomb production. However such use can reduce extruder throughput, and in any event is not sufficient for the extrusion of honeycombs of large cross-section, or for the extrusion of smaller substrates where high production rates are required.

Embodiments disclosed herein offer much greater flexibility for managing this problem. In fact, the use of a combination of extruder barrel cooling and extruder screw cooling enables a measure of control over the development of thermal gradients in the extrudate charge that cannot be achieved by either cooling method alone. Accordingly processes that reduce the peripheral temperature of the charge of plasticized ceramic material prior to extruding, e.g., through the use of extruder barrel cooling, can further improve the effectiveness of screw cooling as a control measure. In carrying out such processing, peripheral cooling is effective to develop a base core-to-periphery temperature gradient in the plasticized material, while screw cooling shapes that gradient so that both the configuration of the extrudate flow front and the nominal temperature of the extrudate as a whole can be managed.

In general, the step of actively cooling the extrudate in accordance with the present disclosure will involve freely circulating a coolant through bores in the central shafts of each of the screw elements. In some embodiments, each such bore will extend through substantially the entire length of the screw shaft, from a shaft inlet opening at the shaft end proximate to the inlet end of the extruder to a bore termination at a bore end proximate to the discharge end of the extruder. In addition, however, the manner in which the delivery and circulation of coolant are accomplished can substantially affect the resulting thermal gradients and level of flow-front control that can be achieved.

Methods for delivering screw coolants to the higher temperature extruder screw segments and regions of plasticized material offer higher levels of control. Inventive extruder screw embodiments best adapted for the targeted delivery of coolant are those wherein the coolant is conveyed into each bore through a coolant delivery conduit extending into the bore from the shaft inlet opening. That conduit will convey the coolant from a conduit inlet opening through the length of each bore to a conduit outlet proximate to the bore end and discharge end of the extruder, where the coolant is then injected into the bore. The coolant thus delivered is then circulated back through the bore through the annular space between the bore wall and coolant delivery conduit, where intimate contact with the bore wall efficiently extracts heat from each of the screws. The screw-heated coolant is then finally discharged from the bore through the annular space surrounding the coolant delivery conduit at the shaft inlet.

The coolant delivery conduit is desirably formed of an insulating material which can minimize heating of the coolant by the screw shafts as the fluid is transported to the bore ends proximate to the extruder discharge end. The latter ends are the points at which the highest screw and extrudate temperatures are observed, and are therefore the locations where the extraction of heat from the system is most effective in controlling the core temperatures of the extrudate. Heat extraction from the screws and the plasticized ceramic material charge in contact therewith can be further enhanced by causing the coolant to traverse back-circulation paths through the bores that include one or more segments of turbulent flow. Bore wall or coolant delivery conduit surface discontinuities may be provided for this purpose.

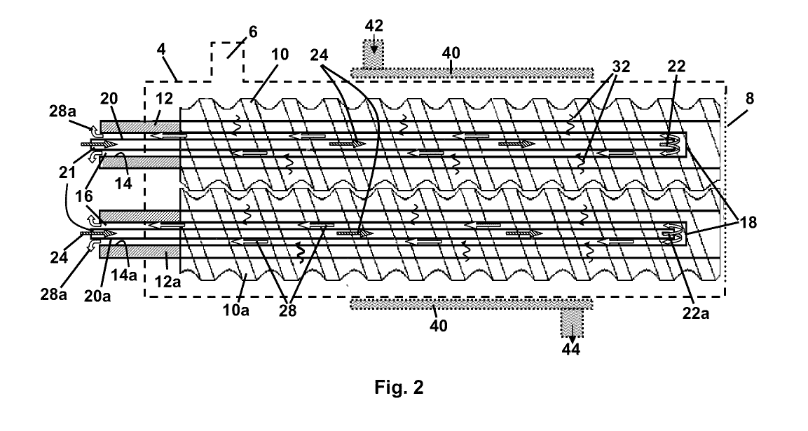

FIG. 2 of the drawings presents a schematic illustration, not in true proportion or to scale, of a co-rotating screw design for a twin-screw extruder generally indicated by outline 4, that screw design incorporating means for effecting efficient screw cooling in accordance with the present disclosure. Referring more particularly to FIG. 2, co-rotating screws 10 and 10a include bored shafts 12 and 12a, those shafts being provided with bores 14 and 14a extending through the shafts from shaft openings 16 proximate to the extruder inlet indicated at 6 to bore ends 18 proximate to an extruder outlet or discharge end indicated at 8. Disposed within each of the bores 14 and 14a are coolant delivery conduits 20 and 20a, those conduits extending into bores 14 and 14a through shaft openings 16 with further extensions along the bores to conduit outlets indicated at outlet arrows 22 and 22a. Those bore ends and the conduit outlets at arrows 22, 22a are in close proximity to the extruder discharge end indicated at 8.

In the course of mixing and plasticizing a ceramic powder mixture input to an extruder 4 at extruder inlet indicated at 6, frictional heating of screws 10 and 10a commences near the extruder inlet at 6 and continues throughout the mixing process such that peak core temperatures are reached in the mixture at points proximate to the extruder discharge end at 8. Managing these temperatures in accordance with the methods of the present disclosure, a fluid coolant is introduced into inlet openings 21 in each of coolant delivery conduits 20 and 20a and transported through those conduits toward the conduit outlets at arrows 22, 22a, the direction of inlet coolant transport being indicated by hatched arrows such as arrows 24 disposed in the coolant delivery conduits in FIG. 2.

The cold fluid is finally delivered into bores 14 and 14a at the closed terminal ends of the bores as indicated by conduit outlet arrows 22, 22a, then being carried back through the bores via the annular channels formed between conduits 20, 20a and the bore walls. The direction of coolant out-flow along the walls of bores 14 and 14a is indicated by open arrows such as arrows 28 disposed in those annular channels. Heat extraction via the out-flowing coolant, from both screws 10 and 10a and from plasticized ceramic powder mixture in contact therewith, is indicated by wavy arrows such as arrows 32 in FIG. 2. Finally, the thus-heated coolant is discharged from the bores of the screw shafts through the annular spaces at shaft openings 16, as indicated by coolant discharge arrows 28a.

Where it is desired to more fully control the thermal profile of the plasticized ceramic powder mixture delivered to the discharge end 8 of extruder 4, means for circulating a barrel coolant about the barrel of extruder 4, such as cooling jacket 40 schematically shown in FIG. 2 of the drawing, may be provided. A coolant for circulation through jacket 40 may be introduced through jacket inlet 42, and discharged from jacket outlet 44 after extracting heat from the extruder barrel. Superior control over that thermal profile will be provided if the temperatures of the coolant introduced into the coolant jacket and the coolant introduced into coolant delivery conduits 20 and 20a are independently controlled, e.g., by separate heat extraction units.

To improve heat transfer from the extruder screws in apparatus such as shown in FIG. 2, it is desirable to maintain the rate of flow of the screw coolant through the central bores of the screw shafts high enough to initiate and maintain turbulent flow through those bores. The flow rates required for this purpose will of course depend upon the volumes of the bores and coolant delivery conduits provided in the extruder being operated, as well as the types of surface discontinuities, if any, provided along the fluid flow paths to develop any turbulence desired to be generated in the coolant flow path. Flow rates sufficient to effect a complete exchange of the total volume of coolant occupying each of the bores within a time interval of from 0.25-2 minutes are generally suitable. However lower rates are useful, especially at higher coolant turbulence levels, and higher rates can be selected where additional cooling capacity is desired. The fluid selected for use in screw cooling systems such as described may be chosen depending upon the design of the system and the level of heat extraction required, but fluids having specific heat capacities of at least about 2 kJ/kg° K, e.g., water or water with additives appropriate for use in water-based cooling systems, are normally effective. The use of a heat-conducting grease between the shafts and screw elements is helpful in further improving heat transfer from the plasticized mixture to the coolant.

In designing extruders for the practice of the methods hereinabove described, attention should be paid to the selection of screw configurations and shaft materials to insure that the levels of torque and fatigue typically encountered in the use of twin screw extruders to process highly-loaded ceramic powder mixtures can be managed. In general, high tensile strength materials will be selected for screw fabrication, e.g., steel or other shaft stock with a tensile strength of at least 2500 kg/cm2, in order the necessary screw strength will be retained following the boring of the screw shafts.

Effective screw designs will also incorporate bore sizes large enough to provide for adequate coolant flow but not so large as to compromise shaft torque limits. FIG. 3 of the drawings plots retained Torque Capacity as a percentage of maximum shaft torque capacity against central Bore Diameter as a percentage of the bored outer shaft diameter. The maximum torque capacity of 100% corresponding to the capacity of a non-bored shaft. The central bore diameters plotted range from about 5% to about 85% of the outer diameters of the shafts.

A useful range of central bore sizes yielding torque capability adequate for twin screw processing with shafts of high tensile strength is outlined within the zone indicated as zone BD in the drawing. Moving outside of zone BD in the direction of arrow LHT can increase torque capacity, but heat transfer to the coolant is low, with coolant pumping pressures being too high and coolant flow rates being less than desired. Moving away from zone BD In the direction of arrow LT will increase coolant flow rates and reduce pressure drops to achieve higher heat transfer, but the torque capacity of the screw shafts can become marginal. Based on data such as presented in FIG. 3, central shaft bores should have diameters not exceeding about 80% of the shaft diameters in order to prevent excessive weakening of the shafts. On the other hand, bore diameters of at least than 20% of the shaft diameters should be provided in order to enable adequate coolant flow, reduce coolant system pressure, and secure adequate heat transfer.

The technical and economic advantages at the methods hereinabove disclosed for the twin-screw processing of plasticized ceramic powder mixtures are substantial. The use of shaft cooling brings a substantial increase in the cooled surface area of these extruders as compared with known twin screw extruders (e.g., increases of 40% in some embodiments). Surprisingly, such increases are sufficient to permit extrudate feed rate increases of 15% or more without significantly increasing honeycomb extrudate shape defects. These improved results are due at least in part to the fact that frictional heat generated in these extruders can now be removed directly from those extruder locations at which much of the heat is generated. Thus localized core cooling that is maximally effective for the reduction of the core-to-periphery temperature gradients most responsible for core extrudate fast flow is provided. Further, the use of screw cooling in combination with peripheral cooling via extruder barrel cooling enables greatly improved flow front control, manifested in flatter twin-screw flow fronts than attainable by any other known means.

Finally, the combined use of extruder barrel cooling and screw cooling in further combination with so-called front-end heating or cooling offers even greater control over the thermal profile of plasticized ceramic powder extrudate being delivered to a honeycomb extrusion die, and thus even further improvements in honeycomb extrudate flow front control. Apparatus suitable for effecting front-end heating in single-screw extruders is known, for example from U.S. Patent Application No. 2002/0167102, and such apparatus can be adapted to carry out front-end cooling in combination with screw cooling and barrel cooling in the practice of the twin-screw extrusion methods disclosed herein. More particularly, utilizing such apparatus to carry out a further step of front-end heating or cooling of a charge of plasticized ceramic powder mixture as that mixture is transferred from the discharge end of the extruder to the honeycomb extrusion die constitutes yet a further advantageous embodiment of the disclosed methods.

While the foregoing description has presented specific examples and embodiments of the present invention, it will be appreciated that such examples and embodiments have been offered for purposes of illustration only, and that a wide variety of alternative embodiments may be adopted by the artisan for particular purposes within the scope of the appended claims.

We claim:

1. A method for shaping a plasticized inorganic powder mixture comprising a step of processing the mixture through a screw extruder incorporating a combination of barrel cooling and screw cooling.

2. A method in accordance with claim 1 wherein the mixture is processed through a twin-screw extruder incorporating a pair of actively cooled co-rotating screw elements.

3. A method in accordance with claim 2 wherein each of the pair of screw elements includes a shaft incorporating a central bore, and wherein each central bore contains a fluid coolant.

4. A method for forming a honeycomb shape from a plasticized ceramic powder mixture comprising the steps of:
reducing a core temperature of a charge of the plasticized ceramic powder mixture during transit of the charge though a twin-screw extruder to provide a temperature-conditioned mixture; and
extruding the temperature-conditioned mixture through a honeycomb extrusion die mounted downstream of a discharge end of the twin-screw extruder.

5. A method in accordance with claim 4 wherein the extruder incorporates a pair of co-rotating screw elements, and wherein the step of reducing the core temperature includes a step of actively cooling each of the screw elements.

6. A method in accordance with claim 5 wherein the step of actively cooling includes a step of circulating a coolant through a bore in a central shaft of each of the screw elements, each bore extending from a shaft inlet opening at a shaft end proximate to an inlet end of the extruder and each bore terminating at a bore end proximate to a discharge end of the extruder.

7. A method in accordance with claim 6 wherein the coolant is conveyed into each bore through a coolant delivery conduit extending into the bore from the shaft inlet opening, and wherein the coolant is discharged into the bore from a conduit outlet proximate to the discharge end of the extruder.

8. A method in accordance with claim 7 wherein the coolant traverses a circulation path through each bore that includes at least one segment of turbulent fluid flow, and wherein the coolant is discharged from each bore through an annular space surrounding the coolant delivery conduit at the shaft inlet opening.

9. A method in accordance with claim 8 wherein the coolant is a liquid having a heat capacity of at least 2 kJ/kg° K, and wherein the coolant is circulated through each bore in each central shaft at a flow rate sufficient to effect a complete exchange of the total volume of coolant occupying each bore within a time interval of from 0.25-2 minutes.

10. A method in accordance with claim 4 comprising the further step of reducing the peripheral temperature of the charge of plasticized ceramic powder mixture within the barrel of the twin screw extruder prior to extruding.

11. A method in accordance with claim 10 comprising the further step of front-end cooling or heating the charge of plasticized ceramic powder mixture during transfer of the mixture from the discharge end of the extruder to the honeycomb extrusion die.

12. A twin-screw extruder comprising a pair of co-rotating screw elements disposed within an extruder barrel, each screw element incorporating (i) a shaft provided with a central bore having an opening proximate to an inlet end of the extruder and extending through the shaft to a closed terminal end proximate to a discharge end of the extruder; and (ii) a coolant delivery conduit disposed within the central bore, the conduit having a coolant inlet for a screw coolant proximate to the inlet end of the extruder and a coolant outlet for the screw coolant at a location within the bore and proximate to the discharge end of the extruder.

13. An extruder in accordance with claim 12 wherein each shaft provides an annular coolant discharge opening disposed between the coolant delivery conduit and the central bore at the central bore opening.

14. An extruder in accordance with claim 12 wherein each coolant delivery conduit is formed of a thermally insulating material.

15. An extruder in accordance with claim 12 further comprising means for circulating a barrel coolant about a barrel of the extruder.

16. An extruder in accordance with claim 15 incorporating temperature control means for independently temperature-controlling the screw coolant and the barrel coolant.

17. An extruder in accordance with claim 12 wherein each shaft is formed of a metal having a tensile strength of at least 2500 kg/cm2, and wherein each central bore has a bore diameter within the range of 20-80% of an outer diameter of the shaft
